(19) United States
(12) Patent Application Publication
(10) Pub. No.: US 2011/0007338 A1
(43) Pub. Date: Jan. 13, 2011

(54) INFORMATION PROCESSING APPARATUS, INFORMATION PROCESSING METHOD, AND STORAGE MEDIUM

(75) Inventor: Masaki Kawanishi, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/825,213

(22) Filed: Jun. 28, 2010

(30) Foreign Application Priority Data
Jul. 7, 2009 (JP) 2009-160760

(51) Int. Cl. G06F 3/12

(52) U.S. Cl. 358/1.14

(57) ABSTRACT

An information processing apparatus stores first setting information included in a received first print job. If a second print job has been received within a predetermined time period since a timing of reception of the first print job, if the second print job is a print job related to the first print job, and if second setting information included in the second print job is different from the stored first setting information, a CPU of the information processing apparatus stores the first setting information as printing error information. The CPU searches for printing error information that is the same as third setting information included in a third print job from among stored printing error information. If printing error information that is the same as the third setting information has been extracted, the CPU displays a screen for prompting a user to verify the third setting information on an operation unit.

### BACKGROUND OF THE INVENTION

1. Field of the Invention

The present invention relates to an information processing apparatus and an information processing method configured, if it is determined that print setting information included in a print job has been erroneously or wrongly set by a user, to issue a warning message to that effect to the user, and a storage medium storing a program of the method.

2. Description of the Related Art

In recent years, printing of a document is widely executed from a personal computer (PC). Various applications operate on a PC. More specifically, applications, such as Microsoft Office Excel (hereinafter simply referred to as “Excel”) and Microsoft Office PowerPoint (hereinafter simply referred to as “PowerPoint”) of Microsoft Corporation are widely used.

However, if undesired print setting information has been stored in application data or if a user has set wrong setting information, then a product not desired by the user may be output. More specifically, if the number of prints has been set and stored as a page setting for Excel, the setting is applied as the number of copies in actually printing a corresponding print job. In other words, in this case, a print product not desired by the user may be output in a plurality of copies because the printing of the print job is executed according to the number of copies previously set and stored for Excel even when the user intended to print only one copy, which is a default value of the number of copies to be printed.

In another case, suppose that a user, in printing application data generated by using PowerPoint, desires to print the application data by applying a 6-in-1 printing as a plural-page layout setting. In this case, if the user executes the printing without executing the desired 6-in-1 layout print setting, the default page composition setting for 1-in-1 printing is applied. As a result, a product not desired by the user may be output.

Japanese Patent Application Laid-Open No. 09-46689 discusses a system configured to estimate and appropriately extract a video program that suits a user's taste from among enormous quantity of video programs, and present an extracted video program to the user. The system discussed in Japanese Patent Application Laid-Open No. 09-46689 searches for and extracts a user's taste based on information about the user's history of viewing of video software programs. This system includes a user taste database and updates the user taste database based on the extracted user taste. Thus, the system presents a video software program that is likely to suit the user's taste. Accordingly, this conventional method can extract and present to a user a video software program that suits the user's taste, which is extracted from a database including a plurality of video software programs.

However, the above-described conventional method cannot determine whether setting information included in a print job is setting information desired by a user. Accordingly, by using the conventional method described above, printing may be wastefully executed according to wrong setting information. In addition, in the above-described conventional method, it is necessary to generate a user taste database including vast amount of information.

### SUMMARY OF THE INVENTION

According to an aspect of the present invention, an information processing apparatus includes a receiving unit configured to receive a print job including print data and setting information related to printing of the print data, a setting information storage unit configured to store first setting information included in a first print job received by the receiving unit, a printing error information storage unit configured, if a second print job received by the receiving unit has been received within a predetermined time period since a timing of reception of the first print job, if the second print job is a print job related to the first print job, and if second setting information included in the second print job is different from the first setting information stored by the setting information storage unit, to store the first setting information as printing error information, a searching unit configured to search for printing error information that is the same as third setting information included in a third print job received by the receiving unit, from among the printing error information stored on the printing error information storage unit, and a display control unit configured, if the printing error information that is the same as the third setting information has been extracted by the searching unit, to display a screen for prompting a user to verify the third setting information on a display unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to describe the principles of the invention.

FIG. 1 illustrates an example of a network configuration according to an exemplary embodiment of the present invention.

FIG. 2 is a block diagram illustrating an example of main components of an image forming apparatus according to an exemplary embodiment of the present invention.

FIG. 3 illustrates an exemplary hardware configuration of an image forming apparatus according to an exemplary embodiment of the present invention.

FIG. 4 illustrates an exemplary external appearance of an operation unit according to an exemplary embodiment of the present invention.

FIG. 5 is a flow chart illustrating an example of processing according to a first exemplary embodiment of the present invention.

FIG. 6A illustrates an example of setting information, FIG. 6B illustrates an example of a printing history, and FIG. 6C illustrates an example of printing error information according to an exemplary embodiment of the present invention.

FIGS. 7A and 7B illustrate an example of a display executed according to printing error information.

FIG. 8 is a flow chart illustrating an example of processing according to a second exemplary embodiment of the present invention.

FIG. 9 is a block diagram illustrating an example of main components of an information processing apparatus according to an exemplary embodiment of the present invention.

FIG. 10 is a flow chart illustrating an example of processing according to a third exemplary embodiment of the present invention.

### DESCRIPTION OF THE EMBODIMENTS

Various exemplary embodiments, features, and aspects of the invention will be described in detail below with reference to the drawings.

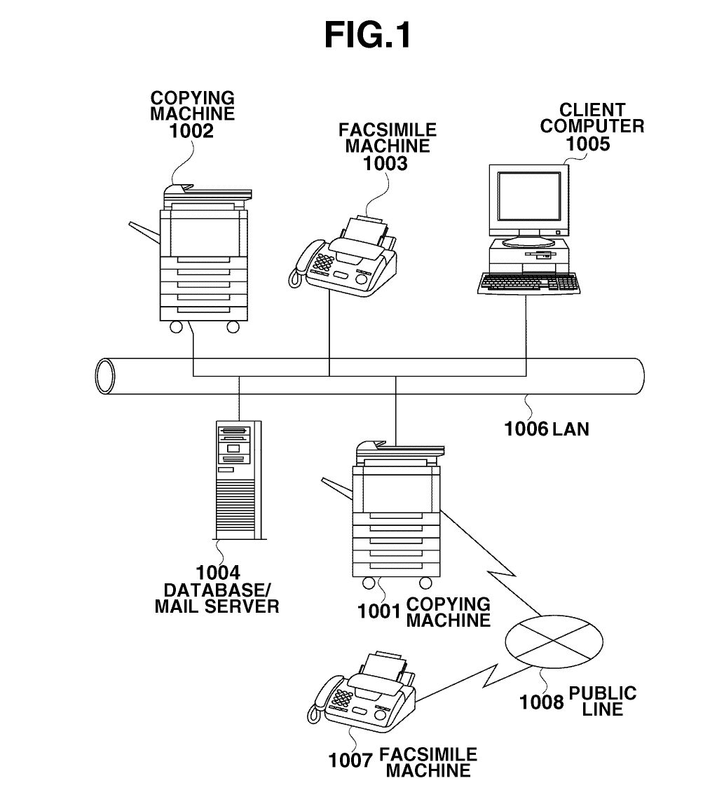

FIG. 1 schematically illustrates an exemplary configuration of a network including an image forming apparatus according to a first exemplary embodiment of the present invention. In the present exemplary embodiment, a copying machine 1001 having a data transmission function is used as the image forming apparatus according to an exemplary embodiment of the present invention. However, the present invention is not limited to a copying machine (image forming apparatus). More specifically, a server (an information processing apparatus) configured to receive a print job from a client PC and transmit the received print job to a copying machine can be used in the present exemplary embodiment.

Referring to FIG. 1, the copying machine 1001, the copying machine 1002 that has the same function as that of the copying machine 1001, the facsimile machine 1003, the database/mail server 1004, and the client computer 1005 are in communication with one another via a local area network (LAN) 1006. The LAN 1006 includes Ethernet, for example. In addition, the network according to the present exemplary embodiment includes a facsimile machine 1007. The copying machine 1001 and the facsimile machine 1007 are connected to a public line 1008.

The copying machine 1001 includes a copy function and a facsimile transmission function. In addition, the copying machine 1001 includes a data transmission function for reading an image of a document and transmitting data of the read image to each apparatus on the LAN 1006. Moreover, the copying machine 1001 includes a page description language (PDL) function. More specifically, the copying machine 1001 is capable of receiving a PDL image indicated by the client computer (client PC) 1005 connected on the LAN 1006 and print the received PDL image.

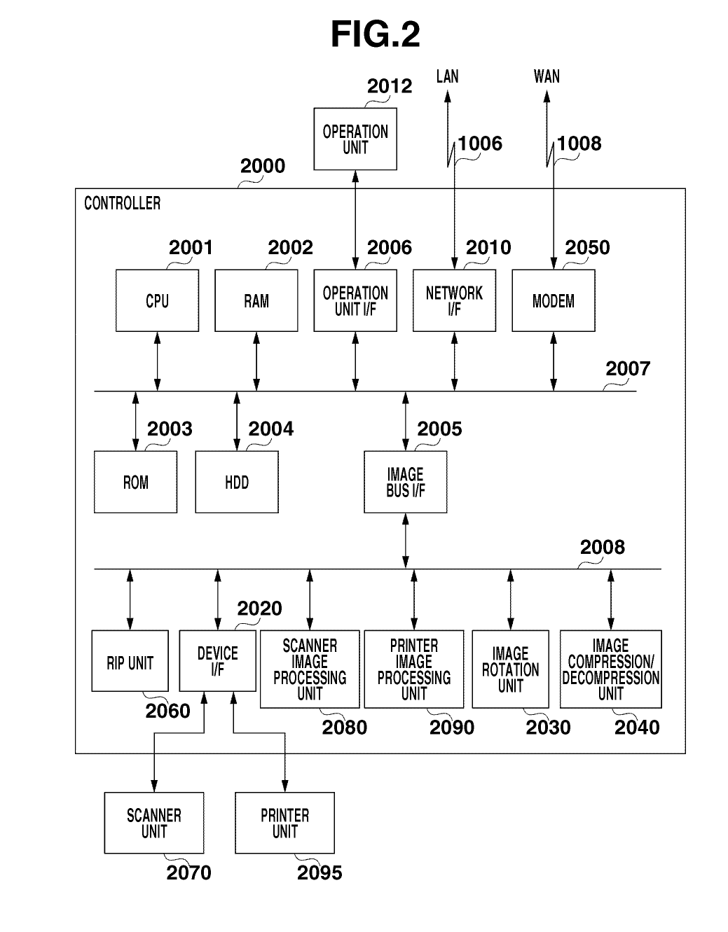

The copying machine 1001 can store an image read by the copying machine 1001 itself and a PDL image indicated by a computer connected on LAN 1006 on a designated box area of a hard disk 2004 (FIG. 2). In addition, the copying machine 1001 can print the image stored on the box area.

The copying machine 1001 can receive data read by the copying machine 1002 via the LAN 1006. Furthermore, the copying machine 1001 can store, print, and output the received data on the hard disk 2004 of the copying machine 1001. In addition, the copying machine 1001 can receive an image stored on the database/mail server 1004 via the client computer 1005 and the LAN 1006. Moreover, the copying machine 1001 can store, print, and output the received image within the copying machine 1001.

The facsimile machine 1003 can receive data read by the copying machine 1001 via the LAN 1006. In addition, the copying machine 1001 can transmit the received data. The database/mail server 1004 is a server apparatus having a function for receiving data read by the copying machine 1001 via the LAN 1006, storing the received data on a database, and transmitting the data as a file attached to an e-mail.

The client PC 1005 is connected to the database/mail server 1004. The client computer 1005 can acquire data desired by a user from the database/mail server 1004 and display the acquired data. In addition, the client PC 1005 can receive data read by the copying machine 1001 via the LAN 1006, and process and edit the received data. Furthermore, the client PC 1005 can transmit a print job to the copying machine 1001 via a printer driver installed within the client PC 1005.

The facsimile machine 1007 can receive data read by the copying machine 1001 via the public line 1008, and print and output the received data.

FIG. 2 illustrates an example of a primary configuration of the copying machine 1001 illustrated in FIG. 1. Referring to FIG. 2, a controller 2000 is in communication with various processing units, such as a scanner unit (image input device) 2070, a printer unit (image output device) 2095, and an operation unit 2012. In addition, the controller 2000 controls an operation of each unit. Furthermore, the controller 2000 is connected to the LAN 1006 and the public line (wide area network (WAN)) 1008. Thus, the controller 2000 executes control for inputting and outputting image information and device information.

Now, an exemplary configuration of the controller 2000 will be described in detail below with reference to FIG. 2. A CPU 2001 activates an operating system (OS) by executing a boot program stored on a read-only memory (ROM) 2003. In addition, the CPU 2001 controls an operation of each component of the copying machine 1001 by executing on the OS an application program stored on the hard disk 2004 to execute processing.

A random access memory (RAM) 2002 functions as a work area of the CPU 2001. In addition, the RAM 2002 functions as an image memory area for temporarily storing image data. The HDD 2004 stores the above-described application program and image data.

The CPU 2001 is in mutual communication with an operation unit interface (I/F) 2006, a network I/F 2010, a modem 2050, and an image bus I/F 2005 via a system bus 2007. The operation unit I/F 2006 is an interface with an operation unit 2012, which includes a touch panel. In addition, the operation unit I/F 2006 outputs, to the operation unit 2012, image data to be displayed thereon. Furthermore, the operation unit I/F 2006 transmits information input by the user via the operation unit 2012 to the CPU 2001.

The network I/F 2010 is connected to the LAN 1006. The network I/F 2010 executes data communication with each apparatus on the LAN 1006 via the LAN 1006. The modem 2050 is connected to the WAN 1008. The modem 2050 executes data communication via the WAN 1008.

The image bus I/F 2005 is an interface between the system bus 2007 and an image bus 2008. The bus I/F 2005 is a bus bridge for transferring image data at a high speed and converting data structure. The image bus 2008 includes a peripheral component interconnect (PCI) bus or Institute of Electrical and Electronic Engineers (IEEE) 1394. A raster image processing (RIP) unit 2060, a device I/F 2020, a scanner image processing unit 2080, a printer image processing unit 2090, an image rotation unit 2030, and an image compression/decompression unit 2040 are connected to the image bus 2008.

The RIP unit 2060 is a processor for rasterizing PDL code into a bitmap image. A scanner unit 2070 and a printer unit 2095 are connected to the device I/F 2020. The device I/F 2020 executes synchronous/asynchronous conversion of image data.

The scanner image processing unit 2080 executes correction, image processing, and editing on input image data. The printer image processing unit 2090 executes printer correction processing and resolution conversion on print output image data.

The image rotation unit 2030 executes rotation of image data. The image compression/decompression unit 2040 compresses multivalued image data into Joint Photographic Experts Group (JPEG) image data. Furthermore, the image compression/decompression unit 2040 compresses binary image data into Joint Bi-level Image Experts Group (JBIG) image data, Modified Modified Read (MMR) image data, or Modified Huffman (MH) image data. In addition, the image compression/decompression unit 2040 decompresses the image data compressed in the above-described format.

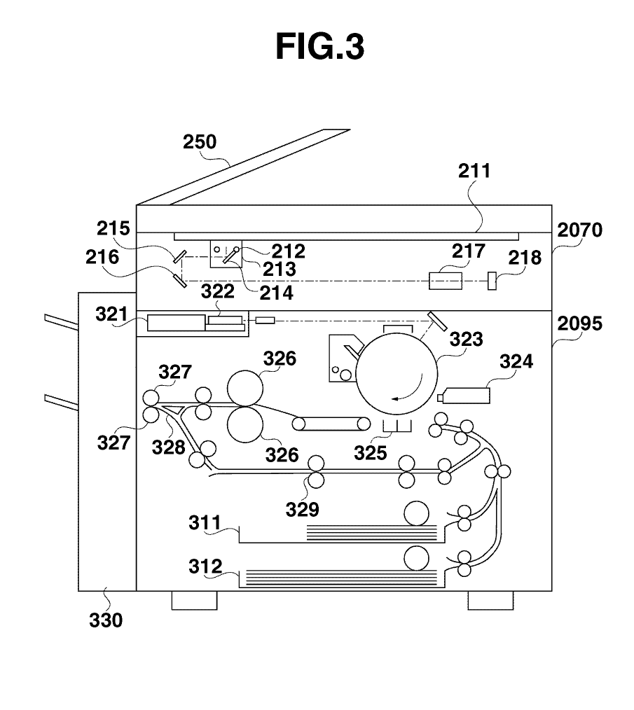

FIG. 3 schematically illustrates an exemplary hardware configuration of the scanner unit 2070 and the printer unit 2095 of the copying machine 1001.

As illustrated in FIG. 3, the scanner unit 2070 and the printer unit 2095 are integrally configured. The scanner unit 2070 includes a document feed unit 250. The document feed unit 250 serially feeds sheets of a document onto a platen glass 211 sheet by sheet starting from a first sheet of the document. When each document is completely read, the document feed unit 250 discharges the read document from the platen glass 211 onto a discharge tray (not illustrated). When the document is fed onto the platen glass 211, the scanner unit 2070 lights a lamp 212 and starts moving a moving unit 213.

By moving the moving unit 213, the document on the platen glass 211 is read and scanned. During the reading and scanning operation, light reflected on the document is guided into a charge-coupled device (CCD) image sensor 218 via mirrors 214 through 216 and a lens 217. Thus, an image of the read document is formed on an image plane of the CCD 218. The CCD 218 converts the image formed on the image plane into an electric signal. After being subjected to predetermined processing, the electric signal is input to the controller 2000.

The printer unit 2095 includes a laser driver 321. The laser driver 321 drives a laser emission unit 322 according to image data input from the controller 2000. Furthermore, the laser emission unit 322 emits a laser beam according to the image data. The laser beam irradiates a surface of a photosensitive drum 323 while being scanned.

When the photosensitive drum 323 is irradiated with the laser beam, an electrostatic latent image is formed on the photosensitive drum 323. The electrostatic latent image is visualized as a toner image by using a toner supplied from a development unit 324. In addition, in synchronization with a timing of the irradiation of the laser beam, a recording sheet is fed from either of cassettes 311 and 312 to a portion between the photosensitive drum 323 and a transfer unit 325 via a conveyance path. The toner image on the photosensitive drum 323 is transferred from the transfer unit 325 on the recording sheet.

The recording sheet having the toner image transferred thereon is conveyed to a fixing roller pair 326 via a conveyance belt. The fixing roller pair 326 includes a heat roller and a pressure roller. The fixing roller pair 326 applies heat and pressure to the recording sheet to fix the toner image on the recording sheet. After passing through the fixing roller pair 326, the recording sheet is discharged by a paper discharge roller pair 327 onto a paper discharge unit 330. The paper discharge unit 330 includes a sheet processing apparatus capable of executing post-processing, such as sorting processing and stapling processing.

If a two-sided recording mode is set, the direction of rotation of the paper discharge roller pair 327 is reversed after the recording sheet is conveyed to the paper discharge roller pair 327. Then, the recording sheet is guided into a re-feed conveyance path 329 by using a flapper 328. The recording sheet guided to the re-feed conveyance path 329 is re-fed between the photosensitive drum 323 and the transfer unit 325 at the above-described timing. Then, a toner image is transferred on a back surface of the recording sheet.

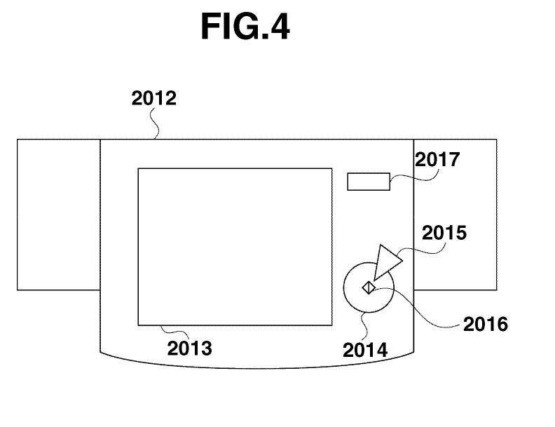

FIG. 4 illustrates an example of the appearance of the operation unit 2012 of the copying machine 1001. Referring to FIG. 4, a liquid crystal display (LCD) unit 2013 includes a touch panel sheet provided on an LCD. The LCD unit 2013 displays a system operation screen. When the user presses a soft key displayed on the LCD unit 2013, the LCD unit 2013 transmits positional information of the pressed key to the CPU 2001 of the controller 2000.

A start key 2014 can be operated to give an instruction for starting an operation for reading an image of a document. At the center of the start key 2014, light-emitting diodes (LEDs) 2018 of two colors of green and red are provided. The LED 2018 indicates whether the start key 2014 is in an enabled state by changing the lighting state of the color thereof. A stop key 2015 can be operated to give an instruction for stopping a currently executed operation. The reset key 2017 can be operated to give an instruction for initializing a setting set via the operation unit 2012.

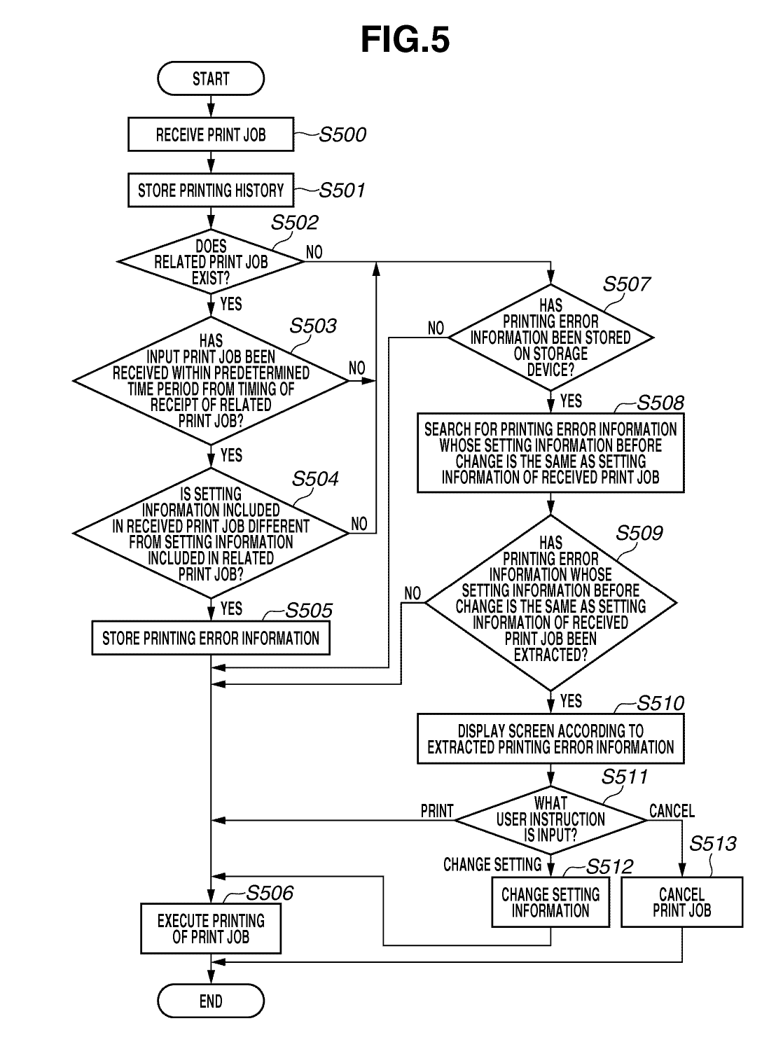

FIG. 5 is a flow chart illustrating an example of processing executed according to the present invention. Processing in each step of the flow chart illustrated in FIG. 5 is implemented by the CPU 2001 by executing a program stored on the hard disk 2004 illustrated in FIG. 2.

Referring to FIG. 5, in step S500, the CPU 2001 receives a print job transmitted from the client PC 1005 via the LAN 1006. In the present exemplary embodiment, a print job includes print data, which is image data to be printed, and setting information used in printing the print data. Furthermore, in the present exemplary embodiment, setting information includes a name of an application used in the printing, the name of the user, a file name, the number of copies, a page layout, and a designation of the range of pages. The contents of the setting information are not limited to those described above. More specifically, it is also useful if the setting information according to the present exemplary embodiment includes information other than the information described above.

In step S501, the CPU 2001 stores setting information included in the received print job and a printing history of the received print job including the date and time of reception thereof (setting information storage processing). It is useful if the RAM 2002 is used as a storage device for storing the setting information and the printing history. Furthermore, it is also useful if the hard disk 2004 is used as a storage device for storing the setting information and the printing history.

In step S502, the CPU 2001 compares the setting information included in the received print job with the printing history already stored on the storage device. In addition, the CPU 2001 determines whether any printing history whose user name and file name is the same as those included in the setting information for the received print job (a related printing history) exists. If it is determined that a related printing history exists (YES in step S502), then the processing advances to step S503. On the other hand, if it is determined that no related printing history exists (NO in step S502), then the processing advances to step S507.

If it is determined that a related printing history exists (YES in step S502), the CPU 2001 determines that a print job related to the received print job (related print job) has already been received by the image forming apparatus. The printing history compared with the setting information of the received print job is a printing history that has been stored before the received job is received except the printing history of the received job itself.

In addition, items based on which the CPU 2001 executes the determination are not limited to the user name and the file name. More specifically, it is also useful if items with which it can be determined by the CPU 2001 whether the received print job and a print job whose printing history has been stored are related to each other. In other words, if the degree of similarity of print data included in a print job with the printing history is high, it is also useful if the CPU 2001 determines that a related printing history exists.

In step S503, the CPU 2001 determines whether the received print job has been received within a predetermined time period from a timing of reception of the related print job. If it is determined that the received print job has been received within the predetermined time period from a timing of reception of the related print job (YES in step S503), then the processing advances to step S504. On the other hand, if it is determined that the received print job has been received not within the predetermined time period from a timing of reception of the related print job (NO in step S503), then the processing advances to step S507.

More specifically, suppose that a predetermined time period of five minutes has been set. In this case, if it is determined that a print job has been received within five minutes since the timing of reception of the received print job, then the processing advances to step S504. On the other hand, if it is determined that a print job has been received after a time period of five minutes or longer has elapsed since the timing of reception of the received print job, then the processing advances to step S507. The CPU 2001 acquires the date and time of reception of the received print job by referring to the printing history of the received print job.

In step S504, the CPU 2001 determines whether the setting information included in the print job is different from the setting information included in the related print job. If it is determined that the setting information included in the print job is different from the setting information included in the related print job (YES in step S504), then the processing advances to step S505. On the other hand, if it is determined that the setting information included in the print job is not different from the setting information included in the related print job (NO in step S504), then the processing advances to step S507. The CPU 2001 receives the setting information included in the received print job by referring to the printing history of the received print job.

In step S505, the CPU 2001 stores the setting information included in the related print job as “setting information before change”. In addition, the CPU 2001 stores the setting information about the received print job as “setting information after change”. Furthermore, the CPU 2001 associates the “setting information before change” with the “setting information after change” and manages the mutually associated setting information as printing error information (printing error information storage processing). As described above, the CPU 2001 according to the present exemplary embodiment stores “setting information before change” and “setting information after change” of a print job received within the predetermined time period. By managing the mutually associated setting information, the present exemplary embodiment can enable the user to verify what printing error he has made and what is the content of correction of the printing error.

In step S506, the CPU 2001 prints the print data included in the print job according to the setting information by using the printer unit 2095. In step S507, the CPU 2001 determines whether printing error information has been stored on the storage device. If it is determined that printing error information has been stored on the storage device (YES in step S507), then the processing advances to step S508. On the other hand, if it is determined that printing error information has not been stored on the storage device (NO in step S507), then the processing advances to step S506.

In step S508, the CPU 2001 searches for printing error information whose “setting information before change” is the same as the setting information included in the received print job by referring to the printing error information stored on the storage device.

In step S509, the CPU 2001 determines whether printing error information whose “setting information before change” is the same as the setting information of the received print job has been extracted as a result of the search executed in step S508 (i.e., the CPU 2001 determines whether such printing error information exists). If it is determined that the above-described printing error information has been extracted (YES in step S509), then the processing advances to step S510. On the other hand, if it is determined that no such printing error information has been extracted (NO in step S509), then the processing advances to step S506.

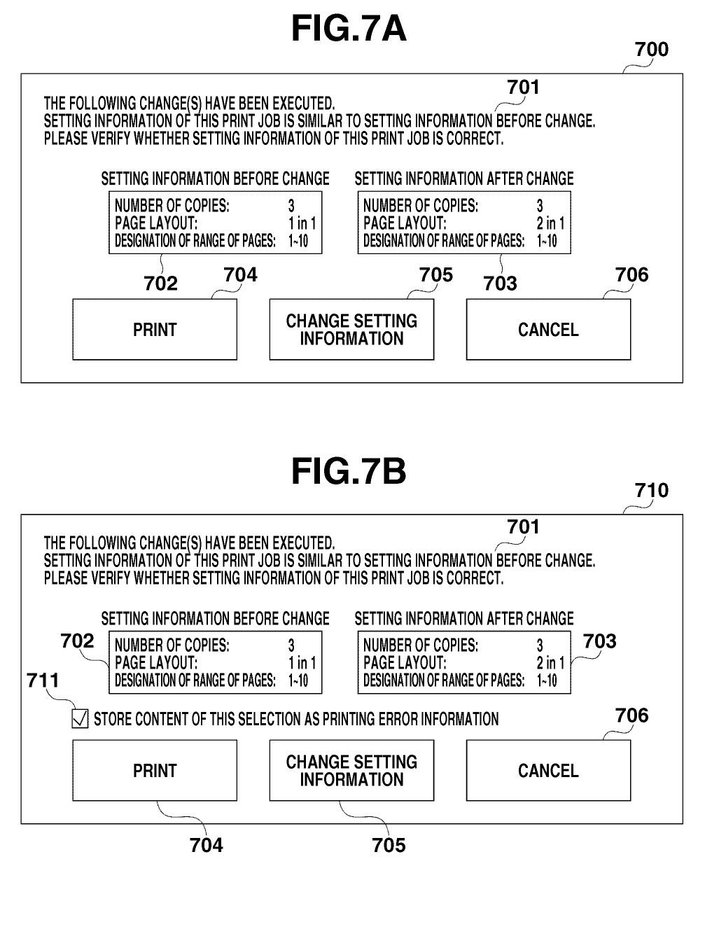

In step S510, the CPU 2001 executes control for displaying a screen that displays a message prompting the user to verify the setting information according to the printing error information extracted as a result of the search on the operation unit 2012. FIG. 7A illustrates an example of a screen displayed in step S510.

Referring to FIG. 7A, a printing error information display screen 700 is displayed on the LCD unit 2013 of the operation unit 2012. The printing error information display screen 700 includes a message display field 701. The message display field 701 displays a message indicating to the user that the setting information set to the received job may be wrong and the user needs to verify the setting information. In addition, the printing error information display screen 700 includes a setting information before change display field 702. The setting information before change display field 702 displays a content stored as the “setting information before change” included in the printing error information.

A setting information after change display field 703 displays a content stored as the “setting information after change” included in the printing error information. If the user has pressed a print button 704, the CPU 2001 determines that a print instruction has been given, and executes control for starting printing of the print job.

If the user has pressed the setting information change button 705, the CPU 2001 determines that an instruction for changing the setting has been given by the user, and executes control for displaying a print setting screen (not illustrated) on the operation unit 2012. By executing the operation described above, the user can change a print setting via the print setting screen.

If the user has pressed a cancel button 706, the CPU 2001 determines that the user has given an instruction for canceling the print job, and cancels the print job. As described above, the CPU 2001 can receive an instruction for printing a print job, an instruction for changing a setting, and an instruction for canceling a print job.

In the present exemplary embodiment, the display displayed in step S510 is not limited to that described above. More specifically, in step S510, any screen can be displayed that prompts the user to verify the setting information of the received print job according to printing error information extracted as a result of the search. In addition, in the present exemplary embodiment, it is also useful if the display in step S510 is executed so as to enable the user to identify an item whose settings of the “setting information before change” 702 and the “setting information after change” 703 are different from each other from an item whose settings of the “setting information before change” 702 and the “setting information after change” 703 are the same. More specifically, in this case, it is also useful if the items whose settings are different from each other are displayed by using a bold face or by using red characters. In this case, the present exemplary embodiment enables the user to easily recognize which item may have a wrong setting.

In step S511, the CPU 2001 determines whether what instruction has been input by the user via the operation unit 2012. If it is determined that an instruction for printing has been input (“print” in step S511), then the processing advances to step S506. On the other hand, if it is determined that an instruction for changing the setting has been input (“change setting” in step S511), then the processing advances to step S512. On the other hand, if it is determined that an instruction for canceling the print job has been input (“cancel” in step S511), then the processing advances to step S513.

In step S512, the CPU 2001 displays the print setting screen on the operation unit 2012. In addition, the CPU 2001 receives the change of setting executed by the user. Furthermore, the CPU 2001 changes the setting information included in the print job according to the content of the setting information input by the user. The present exemplary embodiment changes setting information included in a print job in the above-described manner. However, the present invention is not limited to this. More specifically, it is also useful if the setting information included in the print job is changed to the setting information after change 703 without displaying the print setting screen.

In step S513, the CPU 2001 cancels the print job.

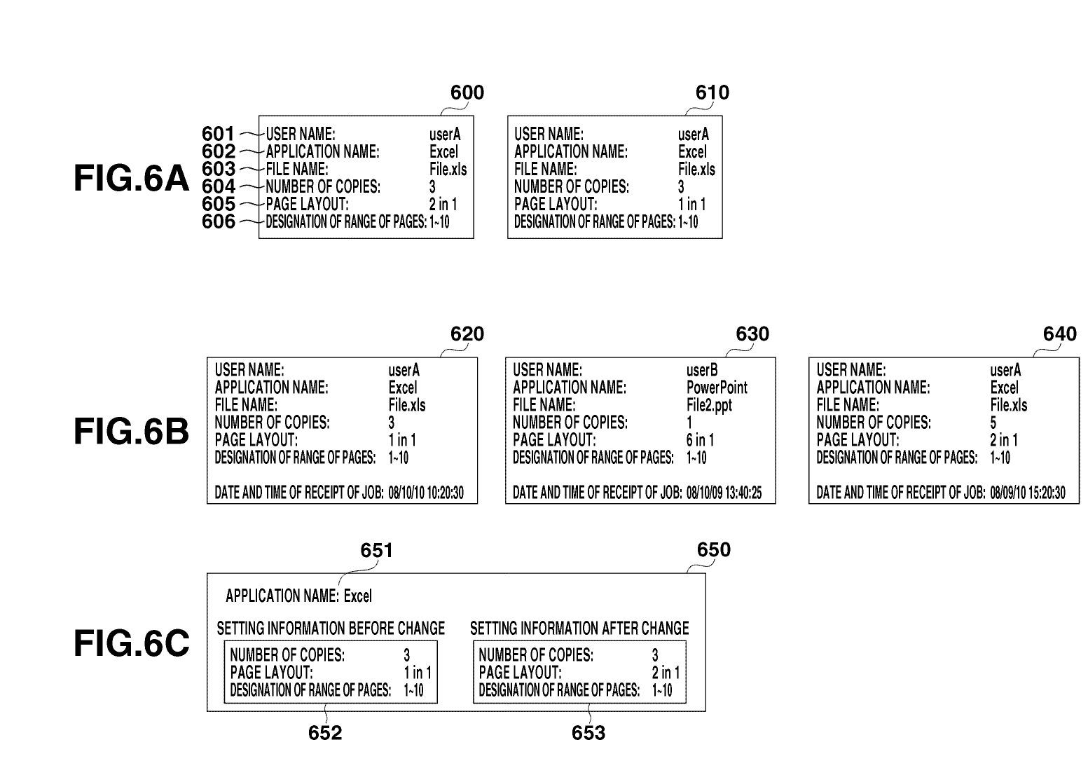

FIG. 6A illustrates an example of the setting information included in a print job. FIG. 6B illustrates an example of a printing history. FIG. 6C illustrates an example of printing error information. To begin with, setting information according to the present exemplary embodiment will be described in detail below with reference to FIG. 6A.

Referring to FIG. 6A, setting information 600 is setting information included in an already received print job. In the present exemplary embodiment, it is supposed that the print job was received from the client PC 1005 at 10:22:30 a.m. of Oct. 10, 2008. The setting information 600 includes the following items. More specifically, the setting information 600 includes a user name 601. The user name 601 includes the name of the user who has executed the printing. In the example illustrated in FIG. 6A, it is supposed that a user A executed the printing.

In addition, the setting information 600 includes an application name 602. The application name 602 includes the name of the application used in the printing. In the example illustrated in FIG. 6A, it is supposed that Excel was used in the printing. Furthermore, the setting information 600 includes a file name 603. The file name 603 includes the name of the printed file. In the example illustrated in FIG. 6A, it is supposed that a file “File1.xls” is printed.

A number of copies 604 is an item indicating the number of copies to be printed. The number of copies 604 is set in printing a plurality of copies of the same print job. In the example illustrated in FIG. 6A, it is supposed that three copies of the print job have been printed. A page layout 605 is an item that indicates a page layout set to the print job. The page layout 605 is set in executing printing print data of a plurality of pages by using a layout in which a plurality of pages is to be printed on the same recording sheet in a reduced state. More specifically, if it is desired to reduce and print data of two pages on one recording sheet, the user sets 2-in-1 printing. In the example illustrated in FIG. 6A, it is supposed that the print job was printed in the 2-in-1 printing mode.

A designated page range 606 indicates the range of pages to be printed. The designated page range 606 is set in printing only pages designated by the user. In the example illustrated in FIG. 6A, it is supposed that pages 1 through 10 are to be printed. Setting information 610 is setting information included in the print job received from the client PC 1005 at 10:20:30 a.m. of Oct. 11, 2008.

Now, an exemplary printing history will be described in detail below with reference to FIG. 6B.

Referring to FIG. 6B, each of printing histories 620, 630, and 640 includes, in addition to the items included in the setting information illustrated in FIG. 6A, an item indicating a job reception date and time, which indicates the date and time of reception of the print job corresponding to the printing history from the client PC 1005. Suppose that each of the printing histories 620, 630, and 640 has been stored on the storage device of the copying machine 1001. Furthermore, suppose that a print job including the setting information 600 and another print job including the setting information 610 have been received. In the following description, processing executed in this case will be described in detail with reference to the flow chart of FIG. 5. In the present exemplary embodiment, it is also supposed that the predetermined time period set in step S503 is five minutes.

At first, the CPU 2001 receives a print job including the setting information 600 from the client PC 1005 at 10:22:30 a.m. of Oct. 10, 2008. In step S502, the CPU 2001 determines that the printing history 620 is a related printing history because the user name and the file name included in the printing history 620 is the same as that included in the received print job (YES in step S502).

In step S503, because the print job including the setting information 600 has been received two minutes after the timing of reception of the print job corresponding to the printing history 620, the CPU 2001 determines that the print job has been received within the predetermined time period (YES in step S503). In step S504, because the parameter value set to the setting information 600 (“2 in 1”) is different from that set to the printing history 620 (“1 in 1”), the CPU 2001 determines that the setting information included in the setting information 600 is different from the setting information included in the printing history 620 (YES in step S504).

In step S505, the setting included in the printing history 620 is stored as the “setting information before change”. In addition, the setting information 600 is stored as the “setting information after change”. Furthermore, the printing history 620 and the setting information 600 are associated with each other. Moreover, the CPU 2001 manages the mutually associated setting information as printing error information 650, which is illustrated in FIG. 6C. The printing error information 650 includes an application name 651, setting information before change 652, and setting information after change 653. After storing the printing error information 650, the print job including the setting information 600 is printed according to the setting information 600.

Then, the CPU 2001 receives a print job including the setting information 610 from the client PC 1005 at 10:20:30 a.m. of Oct. 11, 2008.

In step S502, the CPU 2001 determines that the printing history 620, whose user name and file name are the same as those included in the received print job, is a related printing history (YES in step S502). In step S503, because the print job including the setting information 600 has been received one day after the timing of reception of the print job corresponding to the printing history 620, the CPU 2001 determines that the print job has not been received within the predetermined time period (NO in step S503).

In step S507, the CPU 2001 determines whether the printing error information has been stored. More specifically, in step S507, because the printing error information 650 has been stored, the CPU 2001 determines that the printing error information has been stored (YES in step S507). In step S509, because the setting information 610 includes the same setting information as that included in the setting information before change 652, the CPU 2001 determines that printing error information whose setting information before change 652 is the same as the setting information of the received print job has been extracted as a result of the search executed in step S508 (YES in step S509).

In step S510, the CPU 2001 executes control for displaying the printing error information display screen 700 illustrated in FIG. 7A. The user selects either one of the print button 704, the setting information change button 705, and the cancel button 706 via the printing error information display screen 700.

If the user has pressed the print button 704, the CPU 2001 executes printing according to the setting information 610. On the other hand, if the user has pressed the setting information change button 705, the CPU 2001 displays the print setting screen and executes printing of the print job according to the setting information including the user instruction, which is displayed on the print setting display screen. On the other hand, if the user has pressed the cancel button 706, the CPU 2001 cancels the print job including the setting information 610.

In the present exemplary embodiment, it is supposed that in the example illustrated in FIGS. 6A through 6C, a first print job corresponds to the print job corresponding to the printing history 620. Furthermore, first setting information corresponds to the setting information included in the printing history 620. In addition, a second print job corresponds to the print job including the setting information 600. Second setting information corresponds to the setting information 600. Furthermore, a third print job corresponds to the print job including the setting information 610 while third setting information corresponds to the setting information 610.

The present exemplary embodiment stores the printing error information in the above-described manner. Accordingly, the present exemplary embodiment can prevent wastefully executing unnecessary printing according to a wrong setting by prompting the user to verify the setting information according to the printing error information.

Now, a second exemplary embodiment of the present invention will be described in detail below. In the present exemplary embodiment, a content of a selection by the user, which is executed via a screen displaying a message that prompts the user to verify setting information of a received print job according to printing error information extracted as a search therefor, is stored as printing error information. The copying machine 1001 is employed as an apparatus having a function characteristic to the present invention also in the present exemplary embodiment. However, the present exemplary embodiment is not limited to this. More specifically, a server (an information processing apparatus) configured to receive a print job from a client PC and transmit the received print job to a copying machine can be used in the present exemplary embodiment.

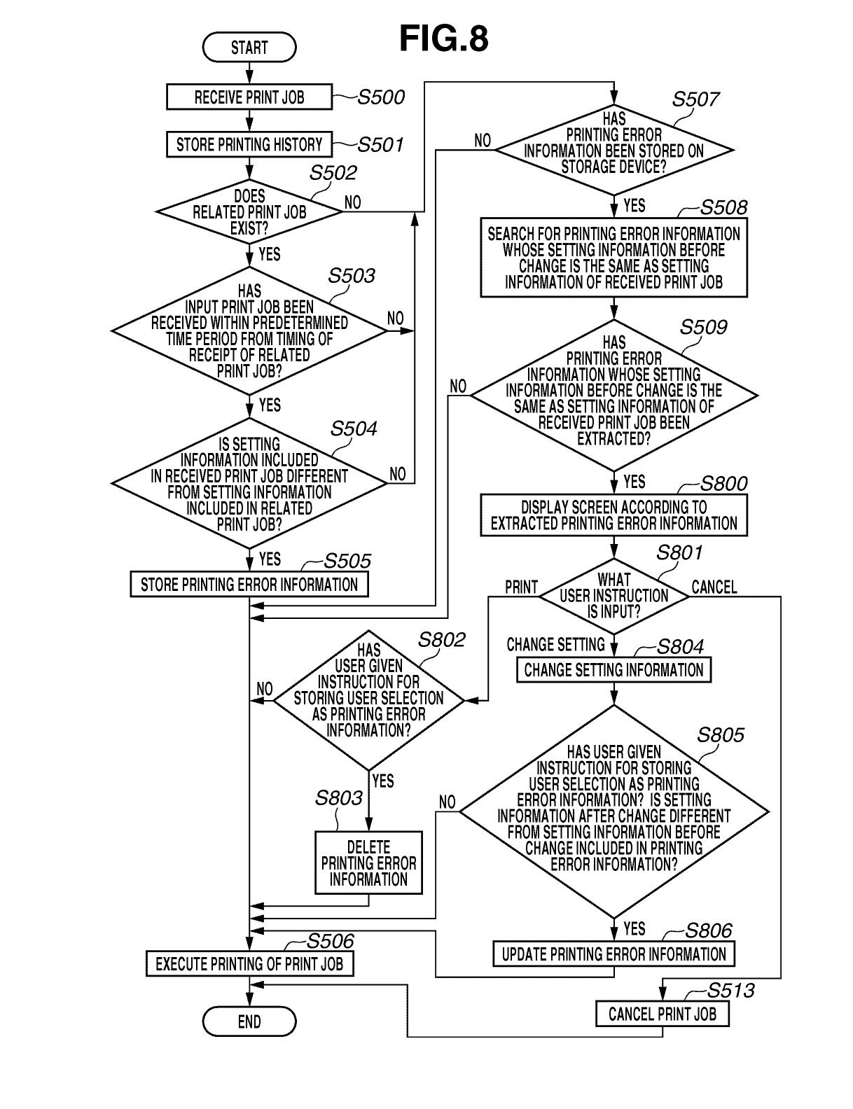

FIG. 8 is a flow chart illustrating an example of processing according to the present exemplary embodiment. Processing executed in steps S500 through S509 and step S513 according to the present exemplary embodiment is similar to that in the first exemplary embodiment. Accordingly, the description thereof will not be repeated here. In the present exemplary embodiment, processing in steps S800 through S804, which is different from that according to the first exemplary embodiment, only will be described in detail.

Referring to FIG. 8, in step S800, the CPU 2001 executes control for displaying, on the operation unit 2012, a screen that displays a message prompting the user to verify the setting information included in the received print job according to the printing error information extracted by the search. FIG. 7B illustrates an example of the screen displayed in step S800.

Referring to FIG. 7B, a printing error information display screen 710 is a screen displayed on the LCD unit 2013 of the operation unit 2012. The printing error information display screen 710 according to the present exemplary embodiment is different from the printing error information display screen 700 according to the first exemplary embodiment in a point that the printing error information display screen 710 includes a selection storage check box 711. If the user checks the selection storing check box 711, the CPU 2001 executes control for storing a content of the instruction selected by the user via the printing error information display screen 710 as printing error information.

In step S801, the CPU 2001 determines what instruction has been input by the user via the operation unit 2012. If it is determined that a print instruction has been input (“print” in step S801), then the processing advances to step S802. On the other hand, if it is determined that an instruction for changing the setting has been input (“change setting” in step S801), then the processing advances to step S804. On the other hand, if it is determined that an instruction for canceling the print job has been input (“cancel” in step S801), then the processing advances to step S513.

In step S802, the CPU 2001 determines whether the selection storing check box 711 has been checked via the printing error information display screen 710 displayed on the operation unit 2012. If it is determined that the selection storing check box 711 has been checked (YES in step S802), then the processing advances to step S803. On the other hand, if it is determined that the selection storing check box 711 has not been checked (NO in step S802), then the processing advances to step S506.

In step S803, the CPU 2001 deletes, from the storage device, the printing error information whose “setting information before change” extracted by the search in step S508 is the same as that included in the setting information for the received print job. As described above, if the print instruction has been input by the user, the CPU 2001 according to the present exemplary embodiment executes control for deleting the printing error information referred to in that case. Accordingly, the present exemplary embodiment can prevent erroneously determining setting information that does not need to be corrected to be possibly wrong setting information in a subsequent print job and beyond.

In step S804, the CPU 2001 displays the print setting screen on the operation unit 2012 and receives a change of setting by the user. In addition, the CPU 2001 changes the setting information included in the print job according to the content of the setting information input by the user.

In step S805, the CPU 2001 determines whether the selection storing check box 711 has been checked via the printing error information display screen 710 displayed on the operation unit 2012. In addition, the CPU 2001 determines whether the setting information after change is different from the “setting information after change” included in the printing error information. If it is determined that the selection storage check box 711 has been checked and that the setting information after change is different from the “setting information after change” included in the printing error information (YES in step S805), then the processing advances to step S806. Otherwise (NO in step S805), then the processing advances to step S506.

In step S806, the CPU 2001 updates the printing error information whose “setting information before change” extracted by the search in step S508 is the same as that included in the setting information for the received print job. More specifically, in step S806, the CPU 2001 updates the “setting information after change” included in the printing error information with the setting information input by the user via the print setting screen.

As described above, if the user has given an instruction for changing the setting, then the present exemplary embodiment updates the printing error information according to the setting information input by the user. With the above-described configuration, the present exemplary embodiment can correct the “setting information after change” to be more appropriate setting information.

Now, a third exemplary embodiment of the present invention will be described in detail below. In the first and the second exemplary embodiments described above, the present invention is applied on the copying machine 1001. In the present exemplary embodiment, the present invention is applied on the client PC 1005, which is an exemplary information processing apparatus. In the present exemplary embodiment, configurations other than those related to the client PC 1005 as characteristic to the present exemplary embodiment are the same as those described above in the first and the second exemplary embodiments. Accordingly, the description thereof will not be repeated here.

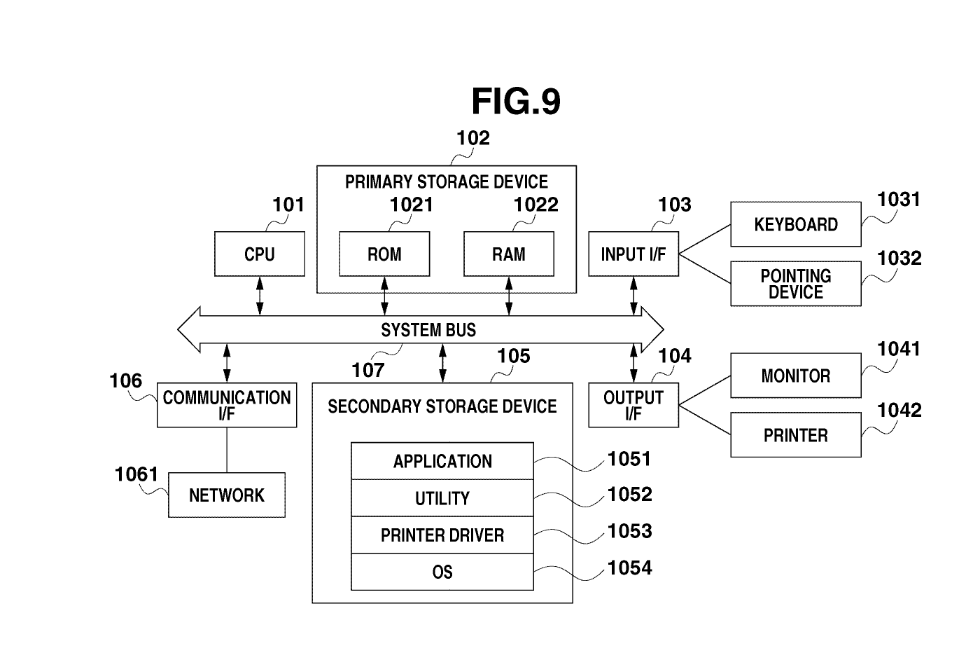

FIG. 9 illustrates an exemplary configuration of the client PC 1005. Referring to FIG. 9, a CPU 101 controls an operation of the entire client PC 1005 according to a program stored on a ROM 1021, a RAM 1022, or a secondary storage device 105. The RAM 1022 functions as a work area for the CPU 101 in executing various processing.

The secondary storage device 105 stores an application 1051, a utility 1052, a printer driver 1053, and an OS 1054. Input devices, such as a keyboard 1031 and a pointing device 1032 including a mouse or a touch panel, can be operated by the user to give various instructions to the computer via an input I/F 103.

An output I/F 104 is an interface for externally outputting data. More specifically, the output I/F 104 outputs data to an output device, such as a monitor 1041 or a printer 1042. It is useful if the output I/F 104 is connected with the printer 1042 not only via a local input/output (I/O) directly but also via a network 1061, which is connected via a communication I/F 106. A common data system bus 107 is used in executing data communication therebetween.

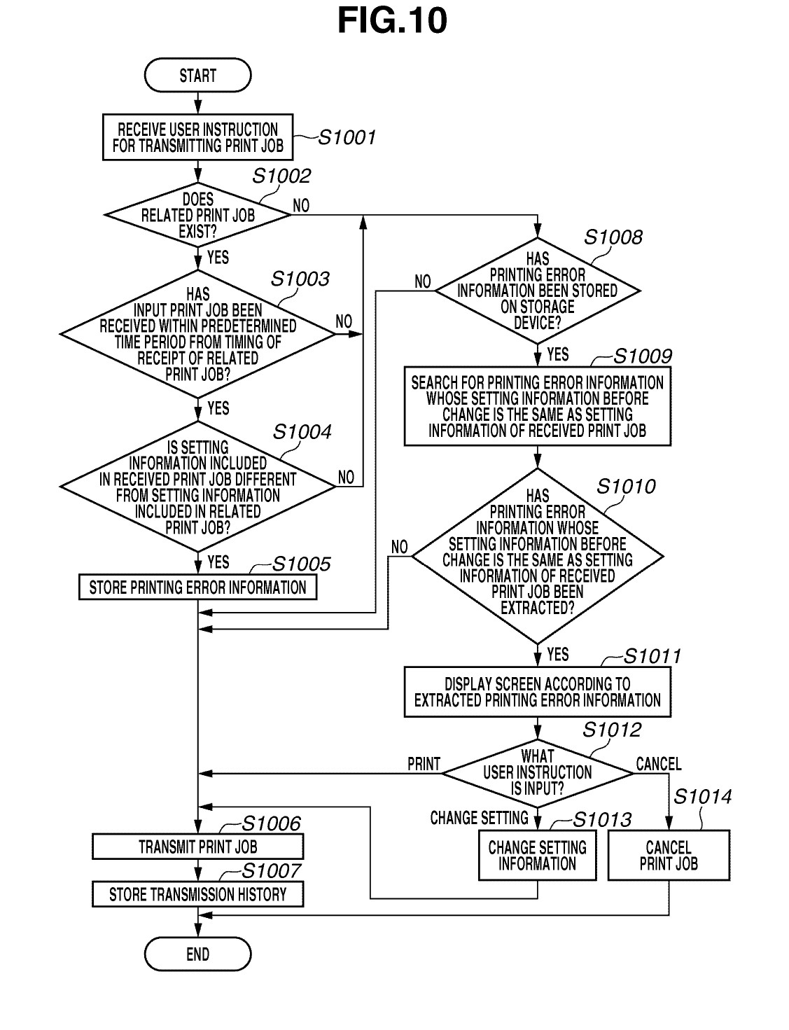

FIG. 10 is a flow chart illustrating an example of processing according to the present exemplary embodiment. Processing in each step of the flow chart illustrated in FIG. 10 is implemented by the CPU 101 by executing a program stored on the secondary storage device 105 illustrated in FIG. 9.

Referring to FIG. 10, in step S1001, the CPU 101 receives a print job transmission instruction from the user, and determines that the print job is to be transmitted.

In step S1002, the CPU 101 compares the transmission history already stored on the secondary storage device 105 with the setting information included in the print job to be transmitted. In addition, the CPU 101 determines whether any transmission history whose user name and filename are the same as those included in the setting information set to the print job to be transmitted (a related transmission history) exists.

If it is determined that a related transmission history exists (YES in step S1002), then the processing advances to step S1003. On the other hand, if it is determined that no such related transmission history exists (NO in step S1002), then the processing advances to step S1008. More specifically, in step S1002, if it is determined that a related transmission history exists (YES in step S1002), then the CPU 101 determines that a print job related to the print job to be transmitted (a received print job) has already been transmitted from the client PC 1005.

In step S1003, the CPU 101 determines whether the print job to be transmitted has been determined to be a transmission target print job within a predetermined time period since the timing of transmission of the related print job. If it is determined that the print job to be transmitted has been determined to be a transmission target print job within a predetermined time period since the timing of transmission of the related print job (YES in step S1003), then the processing advances to step S1004. On the other hand, if it is determined that the print job to be transmitted has been determined to be a transmission target print job not within a predetermined time period since the timing of transmission of the related print job (i.e., that the print job to be transmitted has been determined to be a transmission target print job after a predetermined time period has elapsed since the timing of transmission of the related print job) (NO in step S1003), then the processing advances to step S1008.

More specifically, suppose that the predetermined time period of five minutes has been set. In this case, if the print job has been determined to be a transmission target print job within five minutes since the timing of transmission of the related print job (YES in step S1003), then the processing advances to step S1004. On the other hand, in this case, if the print job has been determined to be a transmission target print job after five minutes has elapsed (e.g., six minutes or eight minutes has elapsed) since the timing of transmission of the related print job (NO in step S1003), then the processing advances to step S1008. The CPU 101 acquires the timing of transmission by referring to a transmission history of the related print job.

In step S1004, the CPU 101 determines whether the setting information included in the print job is different from the setting information included in the related print job. If it is determined that the setting information included in the print job is different from the setting information included in the related print job (YES in step S1004), then the processing advances to step S1005. On the other hand, if it is determined that the setting information included in the print job is not different from the setting information included in the related print job (NO in step S1004), then the processing advances to step S1008. The CPU 101 acquires the setting information set to the related print job by referring to a related transmission history.

In step S1005, the CPU 101 stores the setting information included in the related print job as the “setting information before change”. In addition, the CPU 101 stores the setting information included in the print job to be transmitted as the “setting information after change”. Furthermore, the CPU 101 associates the “setting information before change” with the “setting information after change”. Moreover, the CPU 101 manages the mutually associated setting information as the printing error information (printing error information storage processing).

As described above, the present exemplary embodiment stores the setting information before change and the setting information after change set to the print job that has been determined to be a transmission target print job within the above-described predetermined time period. In addition, the present exemplary embodiment associates the setting information before change with the setting information after change. Furthermore, the CPU 101 according to the present exemplary embodiment manages the mutually associated setting information. With the above-described configuration, the present exemplary embodiment can enable the user to verify what printing error the user has made and what is the content of correction of the printing error.

In step S1006, the CPU 101 transmits the transmission target print job to the copying machine 1001. In step S1007, the CPU 101 stores the setting information included in the transmission target print job and the transmission history including the date and time of transmission of the print job on the secondary storage device 105 (setting information storage processing).

In step S1008, the CPU 101 determines whether the printing error information has been stored on the secondary storage device 105. If it is determined that the printing error information has been stored on the secondary storage device 105 (YES in step S1008), then the processing advances to step S1009. On the other hand, if it is determined that the printing error information has not been stored on the secondary storage device 105 (NO in step S1008), then the processing advances to step S1006.

In step S1009, the CPU 101 refers to the printing error information stored on the storage device to search for printing error information whose “setting information before change” is the same as the setting information included in the print job to be transmitted.

In step S1010, the CPU 101 determines whether printing error information whose “setting information before change” is the same as the setting information set to the print job to be transmitted has been extracted as a result of the search executed in step S1009 (i.e., the CPU 101 determines whether such printing error information exists). If it is determined that such printing error information has been extracted (YES in step S1010), then the processing advances to step S1011. On the other hand, if it is determined that no such printing error information has been extracted (NO in step S1010), then the processing advances to step S1006.

In step S1011, the CPU 101 executes control for displaying a screen that displays a message prompting the user to verify the setting information included in the print job to be transmitted on the monitor 1041 according to the printing error information extracted as a result of the search in step S1010.

In step S1012, the CPU 101 determines what instruction has been input by the user by operating 1031 or the pointing device 1032 via the screen displayed on the printer 1042. If it is determined that an instruction for printing has been input (“print” in step S1012), then the processing advances to step S1006. On the other hand, if it is determined that an instruction for changing the setting has been input (“change setting” in step S1012), then the processing advances to step S1013. On the other hand, if it is determined that an instruction for canceling the print job has been input (“cancel” in step S1012), then the processing advances to step S1014.

In step S1013, the CPU 101 displays the print setting screen on the monitor 1041 and receives the change of setting input by the user. In addition, the CPU 101 changes the setting information set to the print job according to the content of the setting information input by the user.

In step S1014, the CPU 101 cancels the print job.

Exemplary embodiments of the present invention are as described above. However, the present invention is not limited to the above-described exemplary embodiments. More specifically, in each of the above-described exemplary embodiments of the present invention, printing executed by using Excel is described. However, this does not limit the scope of the present invention. More specifically, it is also useful if printing according to an exemplary embodiment of the present invention can be executed by using an application other than Excel, such as Microsoft Office PowerPoint, Microsoft Office Outlook, or other applications.

Furthermore, in each of the above-described exemplary embodiments of the present invention, different settings of the number of copies included in the setting information are used. However, this does not limit the scope of the present invention. More specifically, it is also useful if different page layout settings, different designations of setting of range of pages to be printed, or other different settings are used.

In addition, in the first and the second exemplary embodiments described above, the screen that prompts the user to verify the setting information included in the received print job is displayed on the operation unit 2012 of the copying machine 1001. However, the present invention is not limited to this. More specifically, it is also useful if a screen that prompts the user to verify the setting information included in the received print job on a display connected to a client PC, which has sent the received print job.

The present invention can also be achieved by providing a system or an apparatus with a storage medium storing program code of software implementing the functions of the embodiments or with program code that can be downloaded via a network and by reading and executing the program code stored in the storage medium or downloaded via the network by using a computer of the system or the apparatus (a CPU or a micro processing unit (MPU)). In this case, the program code itself, which is read from the storage medium or downloaded via the network, implements the functions of the embodiments described above. Accordingly, the storage medium storing the program code or an area of a storage device of an apparatus connected to the computer via the network constitutes the present invention.

Exemplary embodiments of the present invention are as described above. However, the present invention is not limited to the exemplary embodiments described above. More specifically, various other modifications or aspects can be employed within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-160760 filed Jul. 7, 2009, which is hereby incorporated by reference herein in its entirety.

What is claimed is:

1. An information processing apparatus comprising:
a receiving unit configured to receive a print job including print data and setting information related to printing of the print data;
a setting information storage unit configured to store first setting information included in a first print job received by the receiving unit;
a printing error information storage unit configured, if a second print job received by the receiving unit has been received within a predetermined time period since a timing of reception of the first print job, if the second print job is a print job related to the first print job, and if second setting information included in the second print job is different from the first setting information stored on the setting information storage unit, to store the first setting information as printing error information;
a searching unit configured to search for printing error information that is the same as third setting information included in a third print job received by the receiving unit, from among the printing error information stored on the printing error information storage unit; and
a display control unit configured, if the printing error information that is the same as the third setting information has been extracted by the searching unit, to display a screen for prompting a user to verify the third setting information on a display unit.

2. The information processing apparatus according to claim 1,
wherein the printing error information storage unit is configured to store the first setting information as setting information before change, to store the second setting information as setting information after change, to associate the setting information before change with the setting information after change, and manage the mutually associated setting information before change and setting information after change as printing error information, and
wherein the searching unit is configured to search for printing error information whose setting information after change is the same as the third setting information.

3. The information processing apparatus according to claim 1, further comprising:
a user instruction receiving unit configured, if the printing error information whose setting information is the same as the third setting information has been extracted as a result of the search by the searching unit, to receive an instruction by the user for the third print job; and
a processing unit configured to process a print job according to the instruction given by the user and received by the user instruction receiving unit.

4. The information processing apparatus according to claim 3, wherein the user instruction that the user instruction receiving unit can receive includes at least one of a printing instruction, a setting changing instruction, and a job canceling instruction.

5. The information processing apparatus according to claim 3, further comprising an updating unit configured to update the printing error information stored on the printing error information storage unit with a content of the user instruction for the third print job received by the user instruction receiving unit.

6. The information processing apparatus according to claim 5,
wherein the user instruction receiving unit is capable of receiving a user instruction for printing the third print job, and
wherein the updating unit is configured, if the user instruction for printing the third print job has been received, to delete the printing error information that is the same as the third setting information from the printing error information storage unit.

7. The information processing apparatus according to claim 5,
wherein the user instruction receiving unit is capable of receiving a user instruction for changing a setting set to the third print job, and
wherein the updating unit is configured, if a user instruction for changing the setting set to the third print job has been received, to update the setting information after change included in the printing error information that is the same as the third setting information with the third setting information.

8. The information processing apparatus according to claim 1, wherein the print job related to the first print job includes a file name and a user name that are the same as the file name and the user name included in the first setting information, of setting information included in the print job.

9. The information processing apparatus according to claim 1, wherein the display unit is connected to another information processing apparatus that has transmitted the third print job to the information processing apparatus.

10. The information processing apparatus according to claim 1, further comprising an image forming unit configured to form an image of the print data according to the setting information.

11. An information processing apparatus comprising:
a transmission unit configured to transmit a print job determined to be a transmission target print job, which includes print data and setting information related to printing of the print data, according to a transmission instruction given by a user;
a setting information storage unit configured to store first setting information included in a first print job transmitted by the transmission unit;
a printing error information storage unit configured, if a second print job determined to be a transmission target print job has been instructed by a user to be transmitted within a predetermined time period since a timing of transmission of the first print job, if the second print job is a print job related to the first print job, and if second setting information included in the second print job is different from the first setting information stored on the setting information storage unit, to store the first setting information as printing error information;
a searching unit configured to search for printing error information that is the same as third setting information included in a third print job determined to be a transmission target print job, from among printing error information stored on the printing error information storage unit; and
a display control unit configured, if the printing error information that is the same as the third setting information has been extracted by the searching unit, to display a screen for prompting the user to verify the third setting information on a display unit.

12. The information processing apparatus according to claim 11,
wherein the printing error information storage unit is configured to store the first setting information as setting information before change, to store the second setting information as setting information after change, to associate the setting information before change with the setting information after change, and manage the mutually associated setting information before change and setting information after change as printing error information, and
wherein the searching unit is configured to search for printing error information whose setting information after change is the same as the third setting information.

13. The information processing apparatus according to claim 11, further comprising:
a user instruction receiving unit configured, if the printing error information whose setting information after change is the same as the third setting information has been extracted as a result of the search by the searching unit, to receive an instruction for the third print job; and
a processing unit configured to process a print job according to the instruction given by the user and received by the user instruction receiving unit.

14. The information processing apparatus according to claim 13, further comprising an updating unit configured to update the printing error information stored on the printing error information storage unit with a content of the user instruction for the third print job received by the user instruction receiving unit.

15. An information processing method comprising:
receiving a print job including print data and setting information related to printing of the print data;
storing first setting information included in a first print job received;
storing, if a second print job has been received within a predetermined time period since a timing of reception of the first print job, if the second print job is a print job related to the first print job, and if second setting information included in the second print job is different from the stored first setting information, the first setting information as printing error information;
searching for printing error information that is the same as third setting information included in a third print job received, from among the stored printing error information; and
executing control for displaying, if the printing error information that is the same as the third setting information has been extracted as a result of the searching, a screen for prompting a user to verify the third setting information on a display unit.

16. The information processing method according to claim 15, further comprising:
storing the first setting information as setting information before change;
storing the second setting information as setting information after change;
associating the setting information before change with the setting information after change;
managing the mutually associated setting information before change and setting information after change as printing error information; and
searching for printing error information whose setting information after change is the same as the third setting information.

17. The information processing method according to claim 15, further comprising:
receiving, if the printing error information whose setting information after change is the same as the third setting information has been extracted as a result of the searching, an instruction for the third print job; and
processing a print job according to a received user instruction.

18. The information processing method according to claim 17, further comprising updating the stored printing error information with a content of the received user instruction for the third print job.

19. A computer-readable storage medium storing instructions which, when executed by a computer, cause the computer to execute the information processing method according to claim 15.

20. An information processing method comprising:
transmitting a print job determined to be a transmission target print job, which includes print data and setting information related to printing of the print data, according to a transmission instruction given by a user;
storing first setting information included in a transmitted first print job;
storing, if a second print job determined to be a transmission target print job has been instructed by a user to be transmitted within a predetermined time period since a timing of transmission of the first print job, if the second print job is a print job related to the first print job, and if second setting information included in the second print job is different from the stored first setting information, the first setting information as printing error information;
searching for printing error information that is the same as third setting information included in a third print job determined to be a transmission target print job, from among stored printing error information; and
executing control, if the printing error information that is the same as the third setting information has been extracted as a result of the searching, for displaying a screen for prompting the user to verify the third setting information on a display unit.

21. A computer-readable storage medium storing instructions which, when executed by a computer, cause the computer to execute the information processing method according to claim 20.
